(19) United States
(12) Patent Application Publication
(10) Pub. No.: US 2026/0352043 A1
(43) Pub. Date: Nov. 5, 2026

(54) SYSTEMS AND METHODS FOR ELECTRIC MACHINES

(71) Applicant: TAU MOTORS, INC., Redwood City, CA (US)

(72) Inventors: Walter Wesley PENNINGTON, III, Menlo Park, CA (US); Gregory Gordon STEVENSON, San Carlos, CA (US); Ethan Bagget SWINT, Redwood City, CA (US); Michael Parker OWEN, Raleigh, NC (US); Matthias PREINDL, New York, NY (US)

(21) Appl. No.: 19/484,281

(22) PCT Filed: May 17, 2024
(86) PCT No.: PCT/US2024/030012

§ 371 Date: Nov. 13, 2025

Related U.S. Application Data
(60) Provisional application No. 63/467,512, filed on May 18, 2023.
(60) Provisional application No. 63/536,302, filed on Sep. 1, 2023.
(60) Provisional application No. 63/553,029, filed on Feb. 13, 2024.

(51) Int. Cl. H02K 1/26; H02K 1/02; H02K 1/24; H02K 3/487

(52) U.S. Cl. CPC H02K 1/26; H02K 1/02; H02K 1/24; H02K 3/487

(57) ABSTRACT

An electric machine includes a rotor body defining a rotor axis and including a back iron, a plurality of shanks extending radially away from the back iron, and a plurality of pole caps each removably coupled to a corresponding one of the plurality of shanks. The back iron, shanks, and pole caps can be made of different materials, and the rotor can be refluxed to vary a pole count of the motor. A pre-tensioned retention wrap is provided to help secure the rotor component together and allow for increased rotor speed. A retaining body is positioned between the rotor body and the retention wrap to compensate for thermal expansion and to maintain the retention wrap within a predetermined tension range.

### CROSS-REFERENCE TO RELATED APPLICATIONS

This application claims the benefit of U.S. Provisional Patent Application No. 63/467,512, filed on May 18, 2023, U.S. Provisional Patent Application No. 63/536,302, filed on Sep. 1, 2023, and U.S. Provisional Patent Application No. 63/553,029, filed on Feb. 13, 2024, each of which is incorporated herein by reference in its entirety.

### REFERENCE REGARDING FEDERALLY SPONSORED RESEARCH OR DEVELOPMENT

Not Applicable.

### BACKGROUND

The present disclosure relates generally to systems and methods for the electric machines, and more specifically, arrangements and methods of manufacture for multi-material rotors, as well as for rotor retention systems and rotors with reconfigurable poles.

### SUMMARY

In accordance with one aspect of the present disclosure, a rotor for an electric machine is provided. The rotor can include a rotor body and a rotor winding. The rotor body can define a rotor axis and a plurality teeth extending radially away from the rotor axis. The rotor body can include a back iron, a plurality of shanks, and a plurality of pole caps. The plurality of shanks can extend radially away from the back iron, and each of the plurality of shanks can correspond to one of the plurality of teeth. The plurality of pole caps can be removably coupled to a corresponding one of the plurality of shanks. The rotor winding can be wound around the plurality of teeth.

In some examples, the plurality of pole caps can made of a first material and one of the back iron and the plurality of shanks can be made of a second material that is different from the first material. In some cases, the first material can be an electric steel and the second material can be a carbon steel. In some cases, the back iron can made from the second material and the plurality of shanks cane made from a third material.

In some examples, the back iron can have a first grain orientation and the plurality of shanks can have a second grain orientation. In some cases, the first grain orientation is oriented along a circumferential direction relative to the rotor axis and the second grain orientation is oriented along a radial direction relative to the rotor axis.

According to another aspect of the present disclosure, an electric machine is provided. The electric machine can include a stator and a rotor configured to rotate relative to the stator. The rotor can include a rotor body, a rotor winding, a retention wrap, and a compliance member. The rotor body can define a plurality of teeth and the rotor windings can be wound around the plurality of teeth. The retention wrap can be wrapped around the rotor body and can be configured to apply a compressive force to retain the rotor winding on the rotor body. The compliance member can be configured to maintain the retention wrap within a predetermined tension range.

According to yet another aspect of the present disclosure, an electric machine with reconfigurable poles is provided. The electric machine can include a stator and a rotor configured to rotate relative to the stator. The rotor can include a plurality of rotor windings wrapped around a corresponding plurality of teeth that extend from a rotor core. The rotor core can be made of magnetizable material and can be configured to be selectively magnetized in a first pole configuration with a first pole count and a second pole configuration with a second pole count that is different from the first pole count.

According to still another aspect of the present disclosure, a rotor assembly of an electric machine is provided. The rotor assembly includes a rotor shaft including a flange disposed on an end of the rotor shaft, a rotor body coupled to the rotor shaft, and a rotor winding supported on the rotor body. The rotor assembly further includes a balance ring that retains the rotor winding on the rotor body. The balance ring defines an inner lip and the flange bends over the inner lip to retain the rotor winding on the rotor shaft.

### BRIEF DESCRIPTION OF THE DRAWINGS

The invention will be better understood and features, aspects, and advantages other than those set forth above will become apparent when consideration is given to the following detailed description thereof. Such detailed description makes reference to the following drawings.

FIG. 1 is a schematic view of an electric machine including a stator and a rotor, according to aspects of the present disclosure.

FIG. 2 is and exploded view of the electric motor of FIG. 1.

FIG. 3 is a cross-sectional view of a first rotor configuration of the rotor of FIG. 1.

FIG. 4 is a cross-sectional view of a second rotor configuration of the rotor of FIG. 1.

FIG. 5 is a cross-sectional view of a third rotor configuration of the rotor of FIG. 1.

FIG. 6 is a cross-sectional view of a fourth rotor configuration of the rotor of FIG. 1.

FIG. 7 is a partial schematic view illustrating magnetic flux paths through the rotor of FIG. 1.

FIG. 8 is a cross-sectional view of a rotor in a first configuration with six rotor poles.

FIG. 9 is a cross-sectional view of the rotor of FIG. 8 in a second configuration with two rotor poles.

FIG. 10 is a schematic illustration of a rotor in a first configuration with eight rotor poles.

FIG. 11 is a schematic illustration of the rotor of FIG. 10 in a second configuration with four rotor poles.

FIG. 12 is a schematic illustration of the rotor of FIG. 10 in a third configuration with two rotor poles.

FIG. 13 is a partial perspective view of a bobbin wound winding installed onto a rotor, the rotor including a circumferential retention wrap.

FIG. 14 is a partial side view of a rotor with an axial retention wrap.

FIG. 15 is a partial top view of the rotor of FIG. 14.

FIG. 16 is a schematic view showing aspects of the rotor of FIG. 14.

FIG. 17 is a plot showing stresses in a keyed pole cap.

FIG. 18 is a plot showing stresses in an un-keyed pole cap.

FIG. 19 is a perspective view of a rotor winding secured in a compliance member configured as a cooling can.

FIG. 20 is a partial section view of a rotor tooth having a pole cap with an angled inner surface.

FIG. 21 is a cross-sectional view of a rotor with balance rings secured by a rotor shaft.

FIG. 22 is a front isometric view of the rotor of FIG. 21 showing the balance rings secured by the rotor shaft.

FIG. 23 is a rear isometric view of the rotor of FIG. 21 showing a balance ring secured by the rotor shaft.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The term “about,” as used herein, refers to variations in the numerical quantity that may occur, for example, through typical measuring and manufacturing procedures used for articles of footwear or other articles of manufacture that may include embodiments of the disclosure herein; through inadvertent error in these procedures; through differences in the manufacture, source, or purity of the ingredients used to make the compositions or mixtures or carry out the methods; and the like. Throughout the disclosure, the terms “about,” “substantially,” and “approximately” refer to a range of values ±5% of the numeric value that the term precedes.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Electric machines can be used to convert electrical potential energy into kinetic energy that can be used to perform work. In some electric machines, such as electric motors or generators, the electric machine includes a stationary component (e.g., a stator) and a rotational component (e.g., a rotor). In electric motors, electric current is translated into electromagnetic fields that exert a mechanical force, or torque, between the stator and the rotor, which may be used to do work. Generators work on similar principles as electric motors but with mechanical force being translated into electric current. While primarily described in terms of rotational force, or torque, the principles described herein are also applicable to linear motors. For example, in some linear motors, the rotor serves as the stationary component while the stator serves as a translated component.

A rotor for an electric machine may include a rotor body defining a rotor axis. The rotor body generally includes a back iron and a plurality of teeth extending radially from the back iron, relative to the motor axis. The teeth are configured to receive and retain a winding, which can be energized to produce a rotor magnetic field that interacts with a stator magnetic field to cause rotation of the rotor. More specifically, each tooth can include a shank extending from the back iron, which a winding can be wrapped around, and a pole cap coupled at a distal end of the shank, which is configured to retain the winding on the rotor body during rotation.

With conventional designs, a rotor body may be made from a plurality of stamped or laser-cut laminations that are stacked together (e.g., in the axial direction) to form the rotor body. Each lamination is a monolithic structure that is formed from a single piece of material (e.g., electrical steel), meaning that the rotor body is effectively made of a single material (although insulating layers may be disposed between laminations to help reduce eddy currents during dynamic magnetic loading). Accordingly, each lamination forms a corresponding axial slice of the rotor body, which includes a portion of the back iron and each of the plurality of teeth (e.g., the shanks and pole caps). While the use of monolithic laminations can simplify construction of a rotor body, it can also result in losses in performance since different regions of a rotor body experience differing levels or rates of change in magnetic flux during normal operation, while the rotor material may only be selected according to the needs of a particular region (e.g., using electrical steel for the entre rotor body due to the rapidly changing magnetic flux at the pole caps).

Correspondingly, the particular design of a rotor may come with certain trade-offs, for example, in a wound field synchronous machine (WFSM), between a copper area and steel area within a given rotor diameter of a WFSM. More copper generally allows for higher rotor excitation for a given current density limit, yielding higher torque/amp, but reduced steel area can result in higher flux densities and magnetic saturation of the rotor, as well as increased mechanical stresses in the steel from centripetal acceleration. Accordingly, depending on the rotor design, a high-performance motor can be limited to a maximum operating speed by the rotational inertial stresses in the rotor, which increases as the rotational speed squared increases, or by the tendency of soft annealed copper windings to plastically deform outward at high speed.

In some cases, to achieve improved performance (e.g., efficiency, torque output, etc.), a WFSM can incorporate a permanent magnet based or assisted rotor, which can incorporate expensive, high coercivity, low permeability magnets (e.g., neodymium). However, these magnets may be oversized for a peak torque condition and to accommodate for performance degradation as the magnets become warm. Further, the state of permanent magnetization of these magnets is fixed and cannot be changed in response to operating conditions. While induction motors can be robust and inexpensive to manufacture, they also have several disadvantages: under light load conditions, they suffer from low power factor and efficiency; speed control is difficult because the machine is inherently a constant speed machine; and they have relatively poor starting torque.

Accordingly, the present disclosure provides for alternative rotor arrangements and configurations that can achieve improved performance (e.g., peak torque, starting torque, efficiency, etc.) over a wide range of operating conditions, as compared with conventional rotor designs (both those with and without permanent magnets). For example, a rotor can be configured as a multi-material rotor body that does not rely on a traditional, monolithic lamination stack. Instead, the various structures of a rotor body can be made as separate components (e.g., as lamination stacks or other construction methods), which can be coupled to one another to form the rotor body, as is generally described below.

To that end, each component of the rotor body can be made from a material that is selected in accordance with the electromagnetic needs of that particular component. For example, pole caps can be made from a first material configured for the rapidly changing magnetic fields and temporary magnetization experienced by the pole caps (e.g., a material with low hysteresis and high magnetic permeability, such as electrical steel), while a rotor back iron or shanks can be made of a second material configured to be magnetized or with an oriented grain to control flux passing through the rotor body between the rotor pole (e.g., a material with comparatively higher hysteresis and lower magnetic permeability, such as carbon steel).

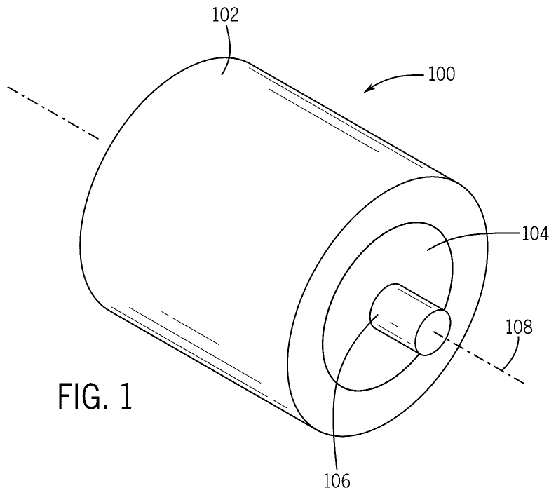

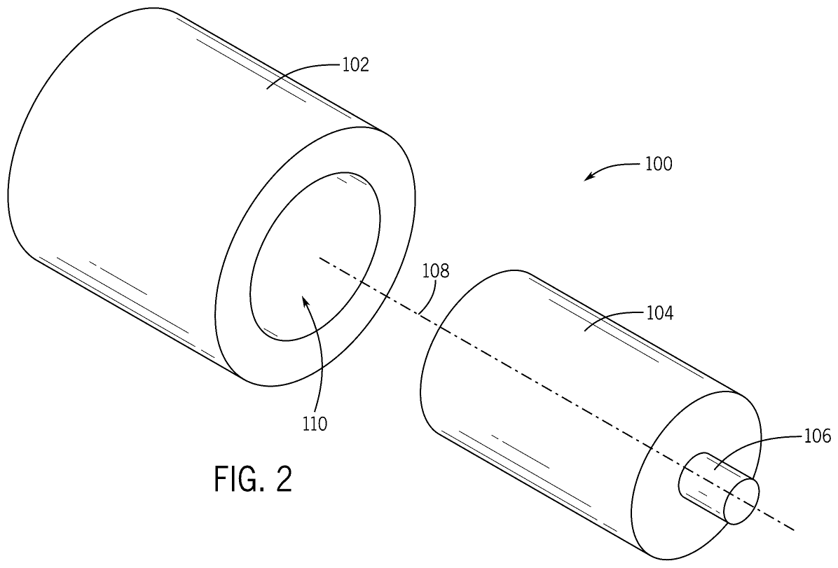

FIGS. 1 and 2 illustrate a non-limiting example of an electric machine 100. The electric machine 100 can be configured as a wound field synchronous motor that includes a stator 102 and a rotor 104 configured to rotate relative to the stator 102; however, the principles described herein are also applicable to other types of electric machines. As generally described above, an electric current can be supplied to windings in the stator 102 to generate a (rotating) stator magnetic field. Correspondingly, an electric current can be applied to windings in the rotor 104 to generate a rotor magnetic field that interacts with the stator magnetic field. More specifically, the stator magnetic field and the rotor magnetic field interact with one another, causing a pushing and/or pulling force on the rotor 104 to rotate the rotor 104 relative to the stator 102. The rotor 104 includes a rotor shaft 106 that defines a rotor axis 108. The rotor 104 and the stator 102 are concentrically aligned about the rotor axis 108, and the rotor 104 is removably coupled to rotate within an internal cavity 110 of the stator 102 about the rotor axis 108. In some examples, the rotor 104 may further include one or more permanent magnets that contribute to the rotor magnetic field and also interact with the stator field to cause rotation of the rotor 104.

As generally described below, the rotor can be configured as a multi-material rotor. A multi-material rotor may include one or more separate components that are coupled together to collectively form the multi-material rotor. Correspondingly, the various components of a multi-material rotor can be made of different types of materials, including, for example, steels (e.g., electric steels, carbon steels, martensitic steels), aluminum, plastics, rubbers, foamed plastics, and fiber-reinforced composites such as fiberglass or carbon fiber.

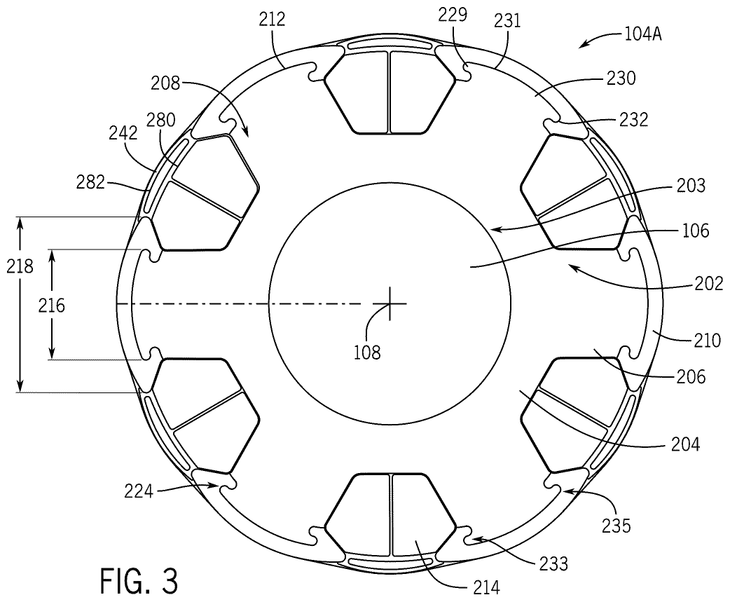

In some cases, a rotor can include a multi-material rotor body, which is configured to support the rotor windings. A rotor body can be configured in a variety of ways to achieve a desired performance characteristic, efficiency, etc. To that end, with additional reference to FIGS. 3-6, the rotor 104 (e.g., rotors 104A-D) generally includes a rotor core or body 202. The rotor body 202 can be arranged to receive a rotor shaft (e.g., rotor shaft 106). For example, the back iron 204 can define an opening 203 and the rotor shaft 106 can be inserted into the opening 203, such that the rotor body 202 can be coupled to the rotor shaft 106.

The rotor body 202 can support the rotor windings and can include a back iron 204 (e.g., which defines the opening 203) and a plurality of teeth 208 extending radially away from the rotor axis 108 to support rotor windings 214. In the illustrated non-limiting example, the rotor 104 includes six teeth, however, other configurations can have a different number of teeth (e.g., two, four, eight, etc. teeth). Each tooth 208 includes a shank 206 coupled to and extending radially away from the back iron 204, and a pole cap 210 coupled at a radially distal end 212 of the shank 206. Put another way, the rotor body 202 generally includes a plurality of shanks 206 and plurality of pole caps 210, which collectively form the plurality of teeth 208.

As generally mentioned above, rotor teeth can be configured to receive and retain rotor windings. As illustrated in FIGS. 3-6, the rotor 104 includes rotor windings 214 that are wound around each of the teeth 208 (e.g., via a bobbin-wound construction). More specifically, each winding 214 is wrapped around one of the shanks 206 and secured on the shank 206 by the pole cap 210. Accordingly, the shanks 206 can have a chord length 216 that is less than a chord length 218 of the pole cap 210. The chord length is a dimension taken perpendicular to both the radial and axial direction of the rotor (e.g., a tangential direction). In this way, a pole cap 210 can define an overhand relative to a corresponding shank 206, which can aid in retaining the winding 214 on the rotor body 202 during rotation.

The back iron, shanks, and pole caps of a rotor body can be coupled in a variety of ways, including, for example, by being directly mechanically coupled between adjacent components or being indirectly coupled via a fastening system, or by being integrally formed with one another (e.g., as a monolithic sub-structure). Correspondingly, a coupling between two or more components can be permanent or removable. Additionally, any of the back iron, shanks, and pole caps can be formed as laminated stacks or monolithically (e.g., as a single, solid piece of material).

For example, in some cases, a back iron and a plurality of shanks can collectively define a rotor core. As illustrated in FIGS. 3-5, the shanks 206 are formed integrally with the back iron 204 to form a rotor core 202. In this case, the rotor core 202 is formed as a lamination stack with a plurality of laminations stacked along the axial direction. Correspondingly, each lamination is formed as a monolithic lamination that includes a corresponding back iron 204 and the shanks 206. Accordingly, each shank 206 extends integrally from the back iron 204 and radially away from the rotor axis 108.

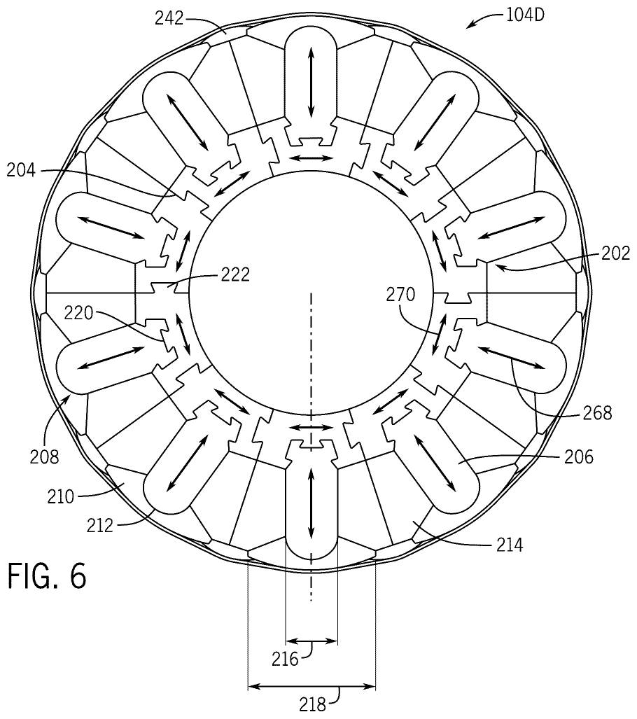

However, in some cases, the shanks are formed separately from a back iron. For example, as illustrated in FIG. 6, each shank 206 is formed separately from and coupled to the back iron 204. More specifically, a mechanical interlock 220, configured here as a dovetail connection, is formed between each shank 206 and the back iron 204 to secure the shanks 206 to the back iron 204. Moreover, the back iron 204 can be configured as a segmented back iron having multiple back iron segments 222 coupled together (e.g., via a mechanical interlock). In this case, each shank 206 is coupled to a corresponding back iron segment 222. In other non-limiting examples, similar principles can be applied to other rotor components (e.g., shanks and pole caps), which can also be segmented.

Correspondingly, a pole cap can be formed as a separate component that is attached to a shank (e.g., a rotor core). As illustrated in FIG. 3, each pole cap 210 is configured as a separate component that is coupled to a respective shank 206. In the present case, each pole cap 210 is coupled to a corresponding one of the shanks 206 via a direct mechanical interlock connection 224. In particular, each shank 206 includes a protrusion 230 which is configured to be received in a socket 232 that is defined by the pole cap 210 (or vice versa). The protrusion 230 is positioned at a distal end of the shank 206, which is opposite a proximal end of the shank 206 that is coupled with the back iron 204. The protrusion 230 and the socket 232 are complementarily shaped and configured so that, when the pole cap 210 is coupled to the shank 206, the interlocking therebetween resists the pole cap 210 from disengaging the shank 206 as a result of the centripetal forces experienced during rotation. In the illustrated example, the protrusion 230 includes opposed lateral flanges 229 that extend (e.g., in a circumferential direction or otherwise substantially perpendicular to the radial direction) from a base 231 of the protrusion 230. Each of flanges 229 is receive in an undercut 233 (e.g., a channel) that is defined in a recess 235 of the socket 232. The particular shape of the protrusion 230 and the socket 232 are configured differently in other examples. In this way, the mechanical interlock connection 224 can operate similar to a dovetail connection and can also retain the windings 214 on the rotor body 202.

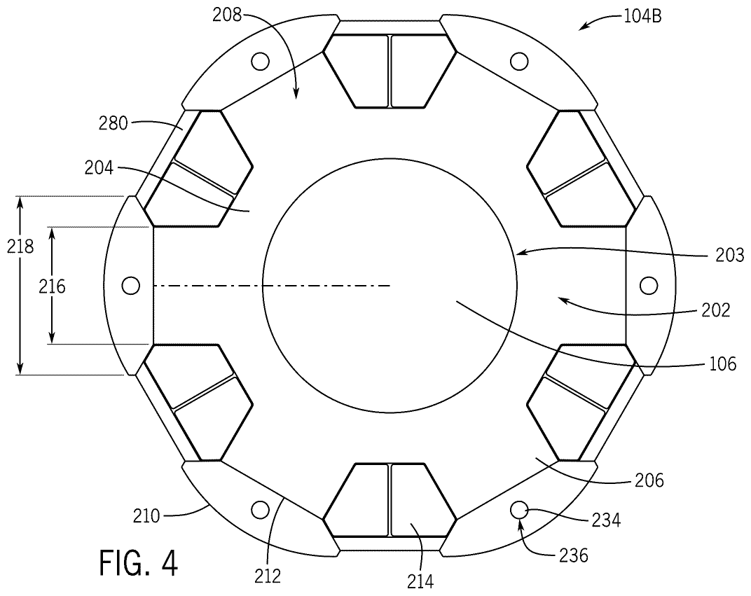

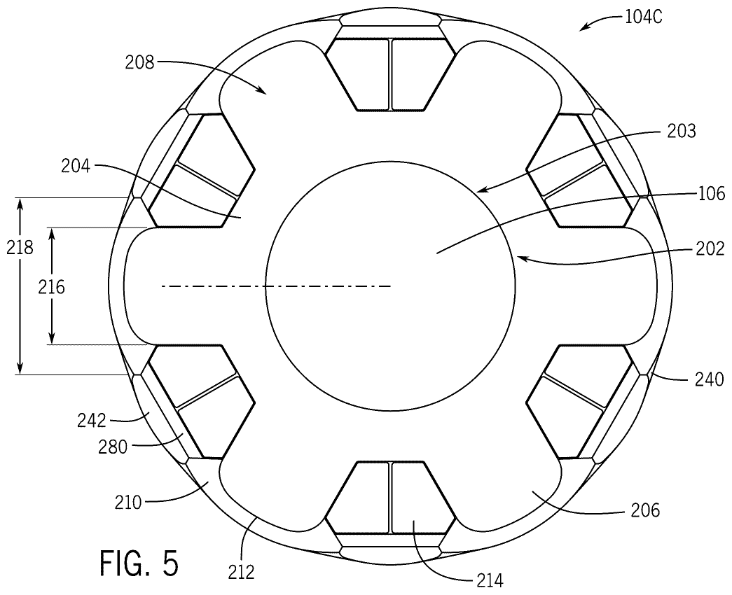

In other non-limiting examples, a pole cap can be retained on a shank in other ways. In particular, a rotor can include a fastening system configured to secure a pole cap to a shank. For example, as illustrated in FIG. 4, a pole cap 210 can be secured to a shank 206 by a fastener 234 (e.g., pin, threaded rod, nut and bolt, etc.). More specifically, a shank 206 can define an aperture 236 that can be aligned with a corresponding aperture of a pole cap 210 so that the fastener 234 can be inserted therein. In this way, the fastener 234 can form a pinned connection between the protrusion 230 and the socket 232 to securely fasten the pole cap 210 to the plurality of shanks 206, and to retain the windings 214 on the rotor body 202. As another non-limiting example, as illustrated in FIG. 5, a pole cap 210 can be secured to a shank 206 by a retention wrap 240. The retention wrap 240 is generally configured to wrap around an outer periphery of the rotor core 202 to apply a radial compression between the pole caps 210 and the shanks 206. Additional details of retention wraps are described in greater detail below.

Because pole caps can be formed separately from the shanks (i.e., rotor core), windings can be installed on a rotor more easily than with conventional rotor designs, which can allow for more compact windings to increase efficiency and power density. More specifically, with conventional windings, the pole caps cannot be removed, windings must be wound in situ about each rotor tooth (e.g., around a shank and underneath a pole cap). However, as illustrated in FIGS. 3-6, because the pole caps 210 of the rotor 104A-D are detachable from the shanks 206, the windings 214 can be wound about the shanks 206 prior to securing the pole caps 210. Alternatively, the removability of the pole caps 210 can also allow the shanks 206 to receive pre-formed windings.

More specifically, a pre-formed winding can be a bobbin-wound winding. Bobbin winding is a process where windings (i.e., the wire that makes up the winding) are wound on a separate bobbin before installation onto the shank 206. The bobbin winding process allows for a higher copper slot fill factor (i.e., a fill ratio or fraction), at least in some examples, due to, for example, being able to fill the slot completely without concern for winding machine interference with the geometry of the rotor core 202 (e.g., the pole caps or shanks). Further, this process also allows the windings to be compressed prior to installation onto the shanks 206, which can be difficult, if not impossible to do with conventional rotor designs that require winding be done in situ. To that end, bobbin wound and compressed windings can achieve slot copper fill factor of about 70%, whereas in situ winding can typically only achieve a fill fraction between about 50% and about 60%. This increase in winding density can allow for a higher winding density, leading to a more power dense and efficient electric machine. Moreover, because bobbin winding can occur separately from installation onto a rotor, installation can be easily parallelized during manufacture and assembly, whereas in situ winding cannot, leading to reduced cycle time.

The formation of integral and separate components can allow different materials to be used in different regions of the rotor. For example, electrical steels can be selectively used in areas that are subjected in intense or rapidly changing magnetic fields (e.g., at or near an air gap between a rotor and a stator, such as at the pole caps). Electrical steels are typically high in silicon content (e.g., up to about 6.5% silicon, or more specifically between about 1% and about 3% silicon, about 2% and 5%, or about 3% and about 6.5% silicon or any range therein), which increases electrical resistivity and, hence, decreases eddy currents and associated losses (e.g., core losses in the rotor core). Further, electrical steels typically have a low carbon content (e.g., less than 0.05% carbon, or more specifically, less than about 0.01% carbon, or less than about 0.005% carbon, or any range therein), which can reduce hysteresis losses and increase magnetic permeability.

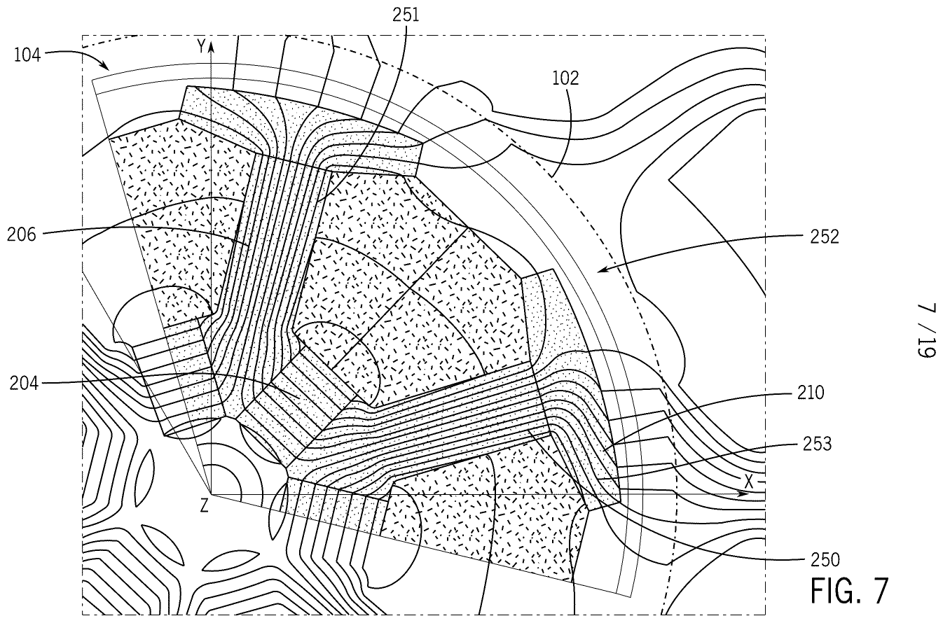

As noted, electrical steels can reduce eddy current and losses due to rapid changes in magnetic flux. Accordingly, in some examples, a rotor core can be me made entirely of electrical steel. However, because rapid changes in flux can be more common in certain areas of a rotor core, in some examples, electrical steel is used in those areas of the rotor core, while other materials are used in the areas that may experience less rapid change in flux. For example, as illustrated in FIG. 7, because this rapid change in flux 250 is dominated by stator tooth/slot passing and typically restricted to a region very close to an air gap 252 between the rotor 104 and the stator 102 (e.g., in the pole caps 210), most of the rotor flux is approximately constant (e.g., in the shanks 206 and back iron 204). Correspondingly, carbon steels can be used in, for example, a rotor core where magnetic flux is generally constant, or where selective magnetization can be helpful to improve rotor performance in accordance with operating conditions (e.g., in the shanks or back iron). Carbon steels typically have a higher carbon content (e.g., between about 0.4% and about 4% carbon, between about 0.4% and 2%, between about 2% and 4%, between about 1% and 3%, or any range between about 0.4% and about 4%) and are generally cheaper than electrical steels. Accordingly, by selectively combining electrical steels and carbon steels in certain configurations, a more efficient and power dense rotor body can be produced as compared with convention rotor constructions.

For example, as illustrated in FIGS. 3-5 and 7, the shanks 206 and the back iron 204, which collectively form the rotor core 202 and are positioned away from the air gap 252, can be made of a carbon steel (e.g., as a lamination stack). The back iron 204 and the shanks 206 provide relatively long arc lengths 251 for the flux 250, which can induce significant magneto motive force (MMF) even at low coercivities achievable from carbon steel. Correspondingly, the pole caps 210, which are positioned immediately adjacent the air gap 252 (e.g., between the rotor core 202 and the air gap 252), can be formed from an electrical steel (e.g., as a lamination stack), as they tend to experience greater changes in magnetic flux than the shanks 206 and the back iron 204 during operation and have shorter arc lengths 253 for the flux 250.

In addition to providing optimal or targeted material usage to help improve motor performance and efficiency, using carbon steels in a rotor core can further improve performance by allowing the rotor to be refluxed and to change the number of rotor poles (i.e., the magnetic poles of the rotor). That is, as generally discussed above, the ability of the carbon steel to be selectively magnetized and demagnetized enables the number of poles to be reconfigured during operation of the motor (on-the-fly). Accordingly, a multi-material rotor in accordance with some examples of the present disclosure can be selectively refluxed into multiple pole configurations with different pole counts, including pole counts that can be different from the tooth count. This reconfigurability contrasts with rotor cores that solely use electrical steels. Such rotor cores generally cannot be refluxed and have a fixed pole count that is equal to the number of rotor teeth.

To control the reconfigurability, a motor can include a controller that can be configured to switch between a first pole configuration and a second pole configuration based on an operating parameter of the electric machine (e.g., a speed command or output, torque command or output, operating temperature, etc.). In some cases, a controller can reflux the rotor by controlling an energization of the stator windings. For example, the stator can include a stator winding and the controller can be configured to control a flow of current in the stator winding that induces a corresponding current in the rotor core to switch the rotor core between the first pole configuration the second pole configuration.

Correspondingly, a rotor can be refluxed to have a particular pole count that can be selected in accordance with an operational parameter or condition of the rotor (e.g., a rotational speed, torque output, etc.), or of a vehicle (e.g., a vehicle speed, drive mode, tow/haul mode, incline, commanded acceleration, etc.). To that end, different numbers of rotor poles may offer enhanced performance at different operating conditions. In particular, higher pole counts generally result in higher torque production, which can be particularly useful at low speeds (e.g., at low vehicle speeds, rotor rotational speeds), during periods of high acceleration, or when going up inclines or when towing or hauling a load. However, at high speeds, higher pole counts typically causes high back EMF currents within the stator, which can limit a maximum achievable speed, increase temperatures, or degrade motor performance. Conversely, lower pole counts are generally favorable for low-torque, high-speed operation, as is common during highway travel. This is because lower pole counts typically produce comparatively less back EMF currents within the stator, allowing for high speeds to be achieved while maintaining high motor efficiencies.

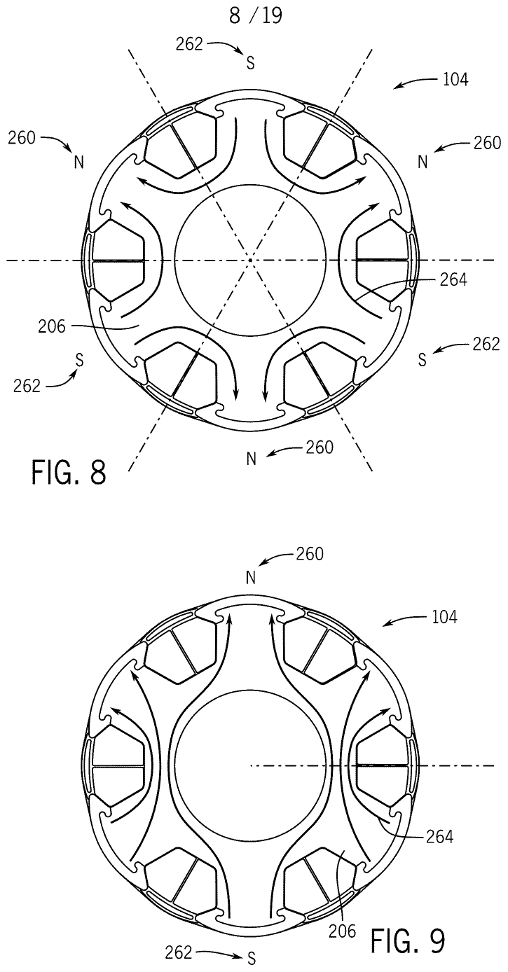

In general, a rotor has an even pole count so that each north pole has a corresponding south pole. For example, FIGS. 8 and 9 depict a rotor 104 with six teeth 208, which can be refluxed into two configurations. In the first configuration shown in FIG. 8 (e.g., a high-torque or low-speed configuration, such as greater than half the rated torque or less than half the rated motor speed), the rotor 104 is refluxed to have a first pole count of six rotor poles. In the first configuration, each tooth 208 defines either a north pole 260 or a south pole 262, with the polarity of adjacent shanks 206 being different from one another. Put another way, the polarity of the teeth 208 is in an alternating pattern, giving a total of three north poles and three south poles, with each north pole having a corresponding south pole on a radially opposite side of the rotor 104. Accordingly, since different polarities are attracted to one another and similar polarities repel one another, the magnetic flux 264 in one tooth extends to each immediately adjacent tooth, which have an opposite polarity.

However, in the second configuration shown in FIG. 9 (e.g., for a low-torque or high-speed configuration, such as less than half the rated torque or greater than half the rated motor speed), the rotor 104 can be refluxed to have a second, different pole count of two poles. In the second configuration, the teeth with like polarities are grouped together to form a first pole 260 on a first half of the rotor (e.g., a first semi-cylindrical region of the rotor including three adjacent teeth 208), and a second pole 262 on a corresponding second half of the rotor (e.g., a second semi-cylindrical region of the rotor including three adjacent teeth 208). Here, the first pole 260 includes three adjacent teeth 208, each with a north polarity, and the second pole 262 which also includes three adjacent teeth 208, each with a south polarity. Thus, the magnetic flux 264 through the rotor 104 in this configuration generally extends from the second pole 262 to the first pole 260.

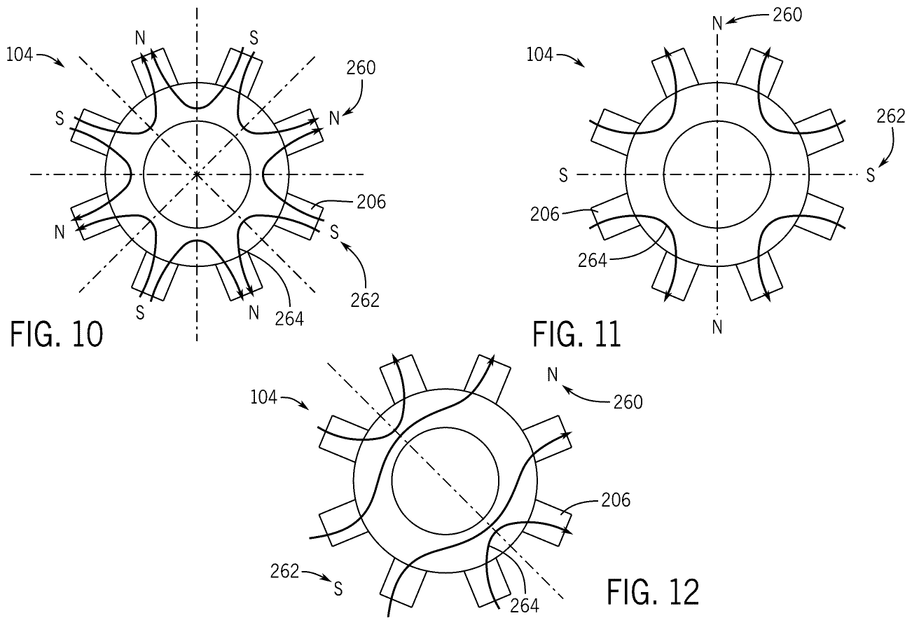

Alternatively, as a non-limiting example, FIGS. 10-12 depict a rotor 104 with eight teeth 208, which can be reconfigured into three different configurations. In the first configuration shown in FIG. 10 (e.g., a high-torque or low-speed configuration, such as greater than two-thirds the rated torque or less than one-third the rated motor speed), the rotor 104 is refluxed to have a first pole count of eight rotor poles, so that each tooth 208 defines either a north pole 260 or a south pole 262, with the polarity of the adjacent shanks 206 being different from one another. Put another way, the polarity of the teeth 208 is in an alternating pattern giving a total of four north poles and four south poles, with each north pole having a corresponding south pole on a radially opposite side of the rotor 104.

In the second configuration shown in FIG. 11 (e.g., a medium-torque or medium-speed configuration, such as between one-third and two-thirds the rotor torque or motor speed), the rotor 104 is refluxed to have a second pole count of four poles. In the second configuration, the two neighboring teeth are grouped together to form a pole at each quadrant of the rotor 104. More specifically, the rotor 104 has a first quadrant defining a first north pole 260, a second quadrant defining a first south pole 262, a third quadrant defining a second north pole 260, and a fourth quadrant defining a second south pole 262, which are arranged in an alternating pattern around the rotor 104. Thus, the magnetic flux 264 through the rotor 104 in the second configuration generally extends from one tooth to each immediately adjacent tooth (i.e., from a tooth immediately adjacent to one of the south poles 262 to a tooth immediately adjacent to one of the north poles 260), such that flux entering a south pole is split to each of the two abutting north poles. For example, flux entering a first tooth of a south pole generally goes to a first north pole and flux entering a second tooth of the south pole generally goes to a second north pole that is opposite the first north pole.

In the third configuration shown in FIG. 12 (e.g., a low-torque or high-speed configuration, such as less than one-third the rated torque or greater than two-thirds the rated motor speed), the rotor 104 is refluxed to a third, different pole count of two poles. Similar to FIG. 9, in the third configuration, teeth 208 with like polarities are grouped together to form a first pole 260 on a first half of the rotor (e.g., a first semi-cylindrical region of the rotor), and a second pole 262 on a corresponding second half of the rotor (e.g., a second semi-cylindrical region of the rotor). Here, the first pole 260 is defined by four adjacent teeth 208, with the remaining four adjacent teeth 208 defining the second pole 262. Thus, the magnetic flux 264 through the rotor 104 in the third configuration generally extends from the second pole 262 to the first pole 260.

In some cases, different material arrangements of a rotor can be used to enhance motor performance in other ways. In particular, grain-oriented steels (GOES) and non-grain-oriented steels (NGOES) can be used in different regions of the rotor in accordance with (e.g., to approximate) an optimal or target flux path through the rotor. NGOES have magnetic grains of the steel that are randomly oriented, providing no preferred or optimum direction for flux. Accordingly, flux in particular directions through the rotor core is not particularly assisted or impeded by the grains—the NGOES provide a generally neutral impact on flux. Thus, NGOES can increase efficiency of rotor operations where the flux lines may not be well aligned in a single direction (e.g., pole caps) or spread out.

In contrast to NGOES, the magnetic grains of GOES are aligned in a particular direction, resulting in magnetic properties that are aligned in a preferred orientation (e.g., to increase magnetic permeability along a particular direction). The orientation of the grain can enable more efficient operations of the rotor by helping to guide magnetic flux along a desired path through the rotor. Further, GOES can also increase the magnetic flux density within a rotor, for example, by approximately 30% as compared with NGOES. However, because the grains are oriented along a particular direction, GOES may exhibit greater losses where flux does not travel along the grain direction. Accordingly, GOES can be advantageously used wherein flux direction is approximately constant along a known direction, such as in the shanks and back iron.

Some rotor cores may include a monolithic structure of entirely NGOES or entirely GOES. However, in some examples, a rotor is provided with a combination of GOES and NGOES, each provided in specific locations of the rotor core, to enable more efficient operations of the rotor. For example, the rotor core may include NGOES where flux lines may not be well aligned in a single direction (e.g., pole caps) or may be less dense. Additionally, the rotor core may include GOES where flux lines are aligned or have comparatively higher density, for example, in the shanks and back iron. Such combinations may obtain the respective advantages of GOES and NGOES, and avoid those aspects of GOES and NGOES that can reduce or limit efficiency.

For example, referring to FIGS. 6 and 7, the orientation of the grain can enable the magnetic properties of the material to substantially align with the flux lines, increase the flux density, allowing for higher torques for a given current density limit, or for reduced rotor core area and increased copper area (e.g., winding area), to lower the required current density. For instance, FIG. 7 illustrates that flux lines 250 typically extend between the back iron 204 and the pole caps 210 in a direction that is substantially perpendicular with respect to the length 216 of the shanks 206 (e.g., in a circumferential and/or radial direction relative to the rotor axis 108). Accordingly, as shown in FIG. 6, the shanks 206 can have a first grain orientation 268 along a first direction (e.g., a radial direction relative to the rotor axis 108) to be substantially parallel to the optimal flux path in the shanks 206. Similarly, the flux lines typically extend along a circumferential or tangential direction within the back iron 204. Accordingly, each back iron segment 222 can have a second grain orientation 270 that is approximately circumferential or tangential relative to the rotor axis 108. In this way, the back iron segments 222 can collectively approximate a circumferential grain orientation in the back iron 204. Correspondingly, the gain orientation of the back iron segments 222 and the shanks 206 can be substantially normal to one another.

As mentioned above, in some cases, a retention wrap can be used to help secure rotor components together, which can allow multi-material rotors to operate at higher speeds (e.g., greater than about 15,000 rotations per minute). Retention wraps may be thin relative to a radial direction of a rotor to minimize impact on the air gap and hence electromagnetic performance (e.g., between about 0.2 millimeters and about 5 millimeters depending on the particular operating conditions, between about 0.2 millimeters and about 1 millimeter, between about 0.2 millimeters and about 2 millimeters, between about 0.2 millimeters and about 3 millimeters). However, thicker wraps can also typically apply greater forces to the rotor (e.g., for a given material of the wrap), allowing for higher speeds, and in some cases, reducing the need for keyed connections between rotor components. In some cases, the retention wrap is made of composite materials, for example, carbon fiber composites, or more specifically uniaxial epoxy carbon composites, for their high strength-to-weight ratio. Correspondingly, a wrapping configuration of a retention wrap on a rotor can be optimized or selected to provide the requisite reinforcement capabilities required by particular application, while also minimizing weight.

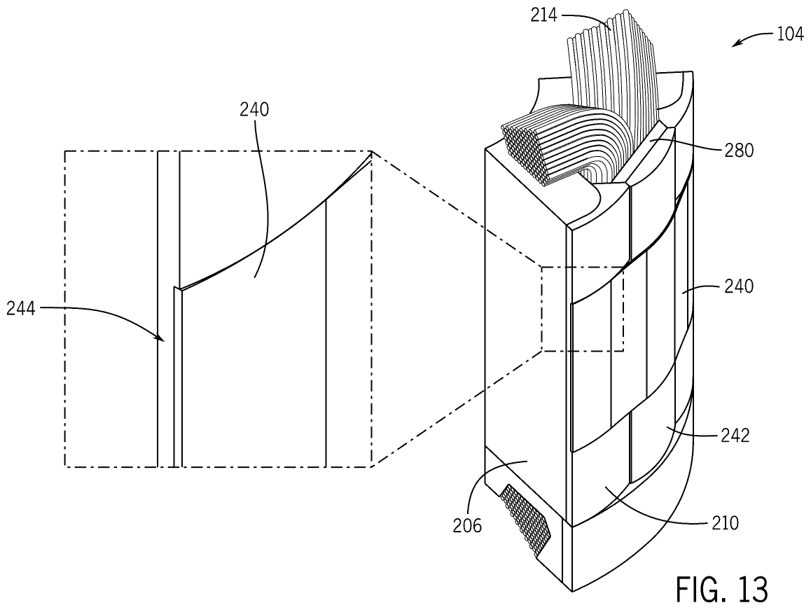

For example, as shown in FIG. 13, in some applications a retention wrap 240 can be configured as a circumferential retention band, which may wrap around some or all of an axial length of the rotor 104. Due to the circumferential configuration, the retention wrap 240 can apply compressive forces along the radial direction to both the windings 214 and to the rotor body 202 (e.g., at the pole caps 210). Correspondingly, the retention wrap 240 can also counteract the centripetal forces experienced by the rotor components during rotation. In other non-limiting examples, more than one retention wrap can be used and they can be positioned anywhere along the axial length of the rotor 104.

In some examples, to allow the retention wrap 240 to more efficiently apply forces to the windings 214, the rotor 104 can include a retainer 242 positioned between the retention wrap 240 and the windings 214 (see also FIGS. 3, 5, and 6). More specifically, the retainer 242 can be positioned within the winding channels between each pair of teeth 208 and can span the inter-pole tip gaps. Circumferential retention wraps may cause a design to have larger air gaps between the rotor 104 and the stator 102 to accommodate for the thickness of the retention wrap. Accordingly, in some examples, to help reduce the air gap, the rotor 104 can define a channel 244 (e.g., a local area or reduced circumference of the rotor body 202), and the retention wrap 240 can be seated within the channel 244. As a result, rotor laminations that are wrapped by the retention wrap 240 can have a smaller diameter to accommodate the presence of the retention wrap 240, while the rotor laminations that are not wrapped can have larger diameters. The combination can result in both a smaller air gap and an improvement in the electromagnetic performance of the electric machine 100.

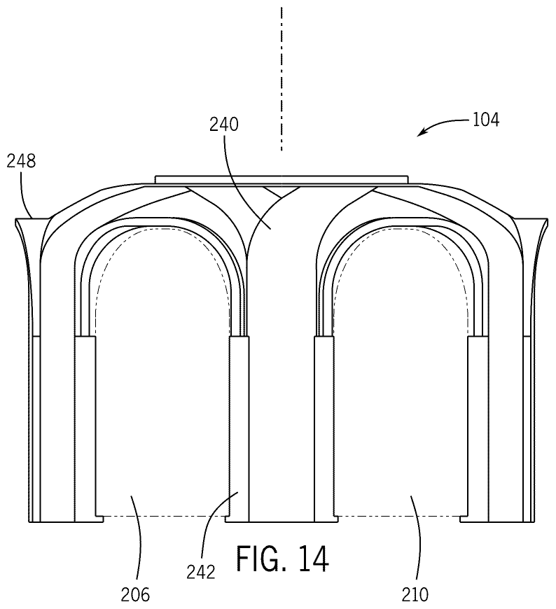

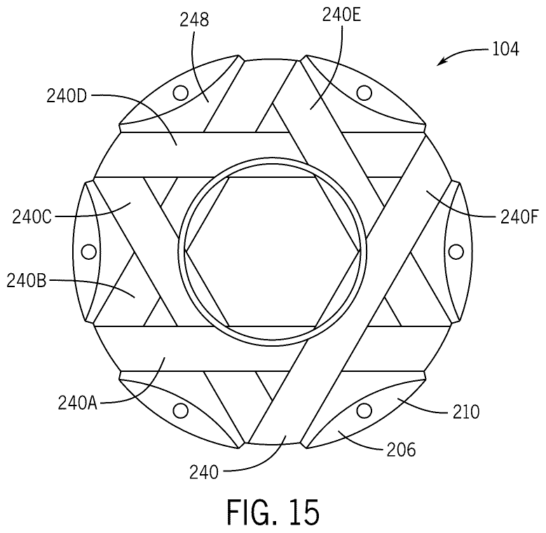

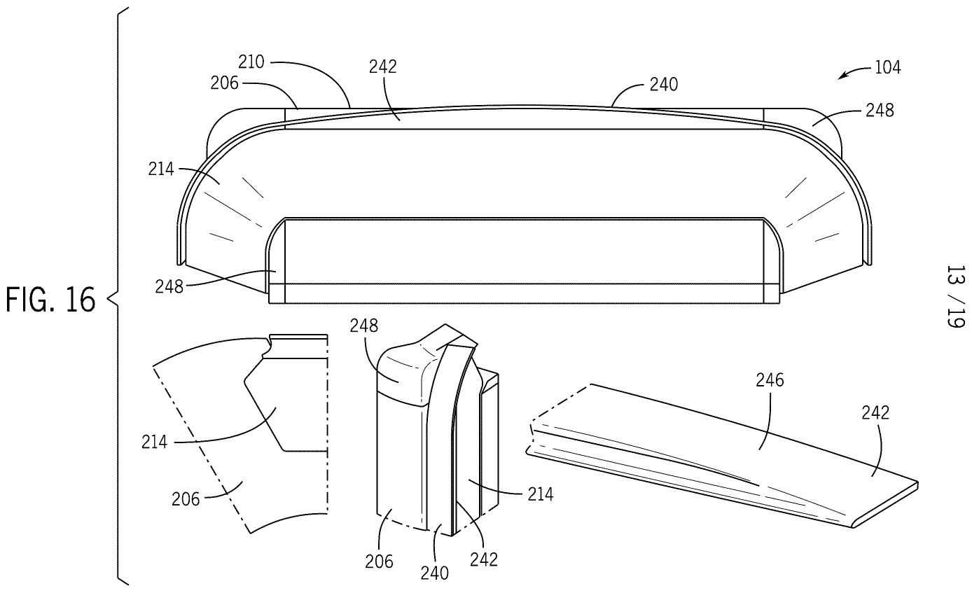

In other examples, as shown in FIGS. 14 and 15, a retention wrap 240 can be configured as an axial retention band. That is, the retention wrap 240 can wrap around two teeth and around each end of the rotor so that the wrap extends axially along the length of the teeth 208 (e.g., perpendicular to the circumferential direction). The axial portion of the retention wrap 240 can be received in and extend along the winding channels between the teeth 208. In this way, the overall diameter can be reduced to minimize the air gap between the rotor 104 and the stator 102. Correspondingly, similar to the circumferential wrapping of FIG. 13, retainers 242 can be positioned between the retention wrap 240 and the windings 214 (see FIG. 16). To help transfer forces radially to the windings 214, in some examples, the retainers 242 have a crowned outer surface 246.

When using an axial wrapping configuration, the rotor may include a plurality of axial retention wraps 240. As best shown in FIG. 15, the rotor 104 includes six axial retention wraps 240A-F. The wraps 240A-F are arranged in a star-shaped pattern with each tooth 208 being wrapped with each immediately adjacent tooth. In other words, the retention wraps 240 span between the two adjacent teeth across the ends of the rotor 104 and along the winding channels. The retention wraps 240 can be arranged in other ways in other examples.

Relatedly, because axial wrapping results in the retention wraps 240 extending around the end of the rotor 104, caps 248 can be provided on the ends of the rotor 104. In some cases, caps 248 can be configured as molded or 3D printed caps formed from plastic, composites (e.g., fiberglass, carbon fiber, etc.), steel, aluminum, or other materials. In some cases, the caps 248 can be configured as end plates for bolting or clamping of the rotor (e.g., to apply an axial compression to the rotor 104), as well as for rotational balancing of the rotor 104. The caps 248 can help to guide, support, and secure the retention wraps 240 between the winding channels. Additionally, the caps 248 can also help to guide, support, and secure the windings 214 between the winding channels (see e.g., FIG. 16). In some cases, the caps 248 can also function similar to retainers by ensuring proper tension in maintained on the rotor 104.

In some cases, a retention wrap can be pretensioned to apply a predetermined compressive force to a rotor (e.g., in a non-rotating state of the rotor). For example, a retention wrap can be wound under tension to apply a radial compressive force to a rotor, pre-loading it compressively so that the various components will maintain contact under rotational inertial load, which represents an “unloading” of the pre-load. The particular pretension may range between about 10% and about 50%, or between about 20% and about 30%, of the ultimate strain of the material of the retention wrap. In this way, the retention wrap can maintain compression on the rotor components despite the centripetal forces that act to reduce the pretension loading during rotation.

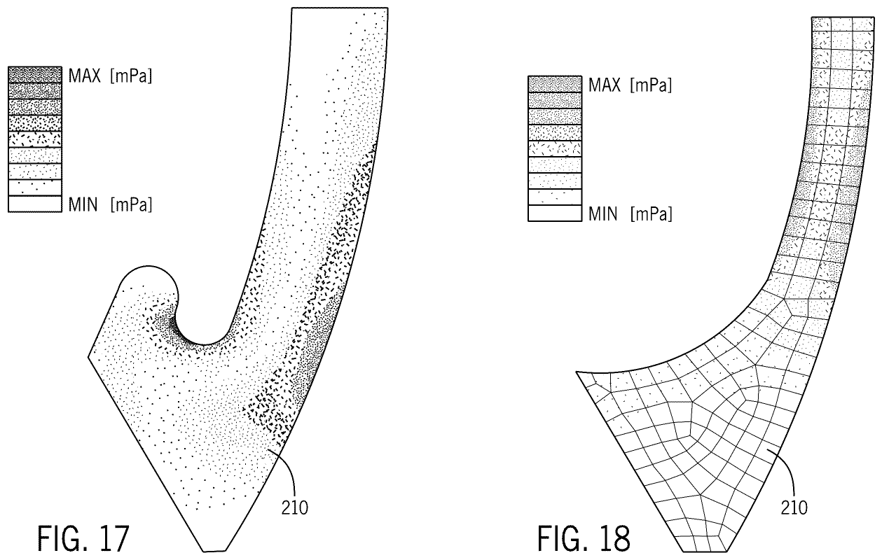

Further, the compression applied to the rotor can reduce stresses in rotor components during operation (e.g., the pole caps), allowing for greater maximum rotational speeds (e.g., achieving speeds of two or more times greater than a rotor what is not wrapped by a pre-tensioned wrap). For example, FIG. 17 illustrates stresses present in a keyed pole cap during rotation of a rotor. By applying a preload with a retention wrap, the stressed within in the pole cap can be reduced, allowing for higher rotational speeds. Moreover, referring to FIG. 18, where the preload is high enough that keyed connections are not needed at the pole caps, the stresses within the pole caps can be reduced even further, allowing for even greater speeds. In each case, the particular pretension can be selected so that the stresses in the pole caps do not exceed the yield strength of the pole cap material.

In some cases, preloading of a retention wrap can be accomplished at lower tensions to simplify the manufacturing process. That is, the total pre-load required in a retention wrap to retain the copper windings, pole caps, and retainers may be thousands to tens of thousands of Newtons depending on the size and intended speed of the machine. Wrapping the entire wrap at the full pre-load tension can be difficult, requiring larger and more robust machinery. However, it is possible to instead perform the wrapping process, at least partially, at a lower tension. In particular, an uncured uniaxial fiber composite (i.e., the fibers that form the retention wrap) may be wrapped a small amount at a time, and in multiple layers, reducing the required wrapping tension while maintaining the total compressive force of the wrap. For example, a circumferential wrap requiring 4,000 pounds of pre-load may be wrapped in two 20 segment layers at a tension of only 100 pounds. The wrap may even proceed a few fibers at a time, or even strand by strand, reducing the required wrapping tension to a few Newtons.

Wrapping of the rotor can begin at very low tension; as the wrapped length increases, friction from the entire previously wrapped length will support higher and higher wrapping tension until the target tension is reached. Similarly, at the end of the wrapping process, the tension may be gradually lowered. This can reduce the need to fix the ends of the wrap at high tension (e.g., with fasteners). Afterward, the wrap can be cured, forming a pre-tensioned, monolithic, uniaxial composite band. In some cases, the ends of the wrap can also be wrapped to reinforce the radial support of the end windings.

While pre-tensioning of a retention wrap allows a composite wrapped rotor to achieve significantly higher speeds than an equivalent unwrapped rotor, the different materials in the retention band and the rotor typically have different coefficients of thermal expansion. For example, the coefficient of thermal expansion of steel can be larger than that of fiber-reinforced composites (e.g., epoxy carbon) that make up the retention wrap. More specifically, the steel in a rotor can have a positive coefficient of thermal expansion, while the retention wrap can have a negative coefficient of thermal expansion. As a result, when the temperature increases, for example, during operation of the motor, the rotor can expand while the retention wrap can shrink. This differential thermal expansion/contraction between the rotor steels and the retention wrap can, in some cases, cause additional stress to develop as temperature increases.

To help account for the differential thermal expansion/contraction between the rotor steels and the retention wrap, a rotor can further include compliance members. Compliance members can be position between the rotor body and the retention wrap and can be configured to flexibly deform to reduce the stress induced by the differential thermal expansion. Specifically, the compliance member can allow a rotor body and the retention wrap to change shape with temperature without substantially changing the outer diameter of the rotor as a whole. Thus, the compliance member allows the rotor body to change shape with temperature as the steels expand while the band (approximately) does not, allowing the outer diameter of the rotor body across the pole caps to increase while the total length of the band remains approximately unchanged, avoiding the increase in the stress in the band. This allows more headroom in the band for pre-tensioning, a thinner band, higher speeds, or some combination thereof. Moreover, the approximately unchanged outer diameter of the rotor allows the retention wraps to continue to apply a desired amount of inward radial force to the rotor (e.g., the pole caps and winding) and mitigate any tendency of gaps to open between distinct sections of rotor body under rotational inertial load. The ability of the compliance members to account for the differing expansions and contractions of the rotor components can result from the material properties or geometric construction of the compliance member.

In some aspects, a compliance member can be configured to contract and/or expand during operation to maintain tension on a retention wrap during operation. For example, during operation heat and centripetal forces can cause expansion of the rotor and contraction of the retention wrap 240 which can result in increased tension, and thus, increased force and stress on the rotor components. However, it is contemplated that a rotor and a retention member may have different thermal coefficients of expansion in other examples, such that heat and centripetal forces can cause expansion of the retention wrap 240. This may result in decreased tension, and thus, reduced force on the rotor components. To counteract this expansion and maintain a (minimum) predetermined tension on the tension wrap 240, a compliance member 280 can also expand, as shown in FIGS. 5 and 13. In that regard, the compliance member 280 may instead be configured as a resilient member that may be pre-loaded by the tension wrap 240. As the centripetal forces cause expansion of the tension wrap 242, the compliance member 280 can expand due to the reduced loading, thereby taking up the expansion of the retention wrap 240 and ensuring proper tension is applied to the rotor. In some cases, the compliance member 280 may undergo thermal expansion due to the temperature increases. This thermal expansion can be sufficient to expand the compliance member 280, thereby taking up the expansion of the retention wrap 240 and ensuring proper tension is applied to the rotor. Relatedly, while only a single retention wrap is depicted, it is appreciated that multiple retention wraps may be used.

In some cases, compliance members can be positioned within winding channels to be between a retention wrap and the coils. For example, as shown in FIGS. 5 and 13, a compliance member 280 can be positioned within the winding channels, between the retention wrap 240 and the windings 214. More specifically, the compliance member 280 can be positioned between the retainer 242 and the windings 214 so that compression forces from the retention wrap 240 are distributed more evenly along the compliance member 280.

Together, a compliance member and a retainer can be a retaining body. To that end, it is also possible that a compliance member and a retainer, can be formed as a unitary retaining body. For example, as shown in FIG. 3, a retaining body 282 is positioned between the retention wrap 240 and the windings 214. The retaining body 282 is specifically shaped to function as both the compliance member 280 and the retainer 242. In particular, the arcuate outer surface can add rigidity to retaining body 282 to function akin to the retainer 242, while the substantially flattened inner surface can provide compliance to function akin to the compliance member 280.

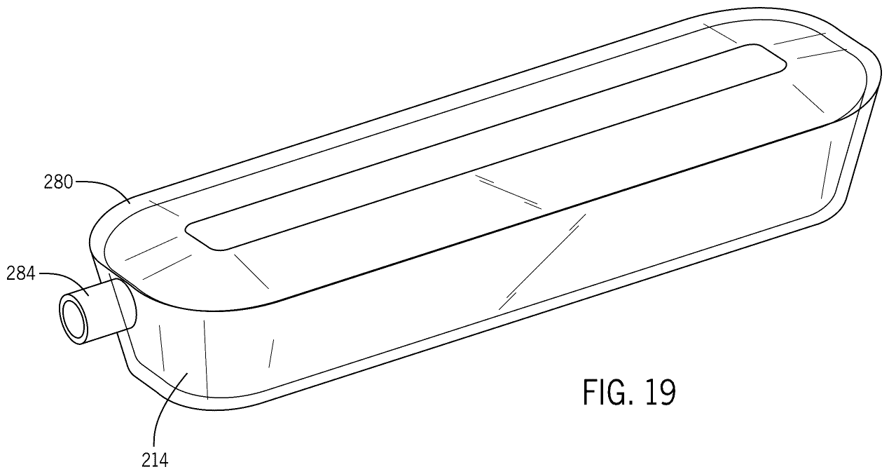

In some cases, a compliance member can also be configured to provide cooling for a rotor. For example, referring to FIG. 19, in some cases, a compliance member 280 can encase the winding 214. In this way, the compliance member 280 can also function as a cooling can 284 to contain and control a flow of coolant around the winding 214. Correspondingly, end caps 248 can be used to form either a tight enclosure, or a plenum, around the end of the rotor windings, or multiple enclosures around individual coil ends, through which a coolant (e.g., ATF oil) can be injected to absorb and reject waste heat from the windings.

Alternatively, the coolant may be forced axially down the length of the rotor between the windings and the rotor core within insulating cooling cans formed by the compliance member 280. To that end, use of bobbin winding and the detachability of the pole caps can enable the use of axial cooling cans because they are otherwise difficult to manufacture in situ on the rotor. Thus, according to the present disclosure a cooling can be secured around a bobbin wound winding prior to installation onto the plurality of shanks.

The use of cooling cans can also allow for higher current densities, by a factor of 2 or more, allowing higher power, torque, and efficiency. Correspondingly, whether a rotor includes a cooling can or not, the rotor can be shaped to allow for greater packing densities of the windings. More specifically, it can be beneficial to shape pole caps with inwardly sloped protruding tips. The protruding tips allow the pole caps to retain the rotor windings and retainers that are used to hold the rotor windings in place, as well as reducing stress induced by the rotor windings and the retainers.

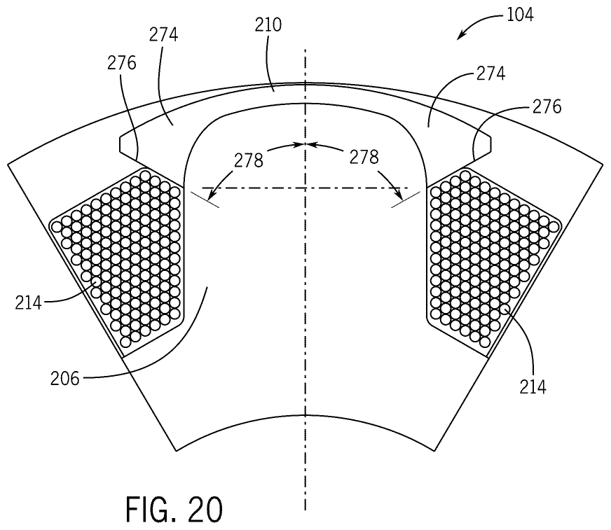

In particular, referring to FIG. 20, a pole cap 210 typically includes protruding tips 274 that extend generally circumferentially away from the shank 206. The tips 274 define a radially inner surface 276 that engages with the windings 214. The inner surface 276 can be angled relative to the radial direction at an angle 278, which can be selected in accordance with a cross-sectional shape of the wires that make up the windings 214. In the case of circular wires, the angle 278 can be an acute angle relative to the radial direction, for example, between about 50 degrees and about 70 degrees, or more specifically about 60 degrees relative to the radial direction. In addition to allowing more dense windings, the angle 278 can also reduce the normal forces applied to the pole caps 210 during rotation, reducing stresses in the material and allowing for greater rotational speeds.

As discussed above, retention wraps can be used to secure rotor components together to facilitate rotor operation at higher speeds. Specifically, retention wraps can be used to counteract the centripetal forces experienced by rotor components during rotation, thus ensuring that the various components therein maintain contact under rotational internal load. Relatedly, caps (e.g., end caps) can be used to further enhance the structural integrity of a rotor by providing axial compression to the rotor with respect to a rotor axis defined by a rotor shaft. In addition, balance rings can be provided to cover an end cap, and a rotor shaft can define a flange to compress the balance rings on either axial end of the rotor, which in turn can secure rotor components together and further maintain contact under rotational inertial load.

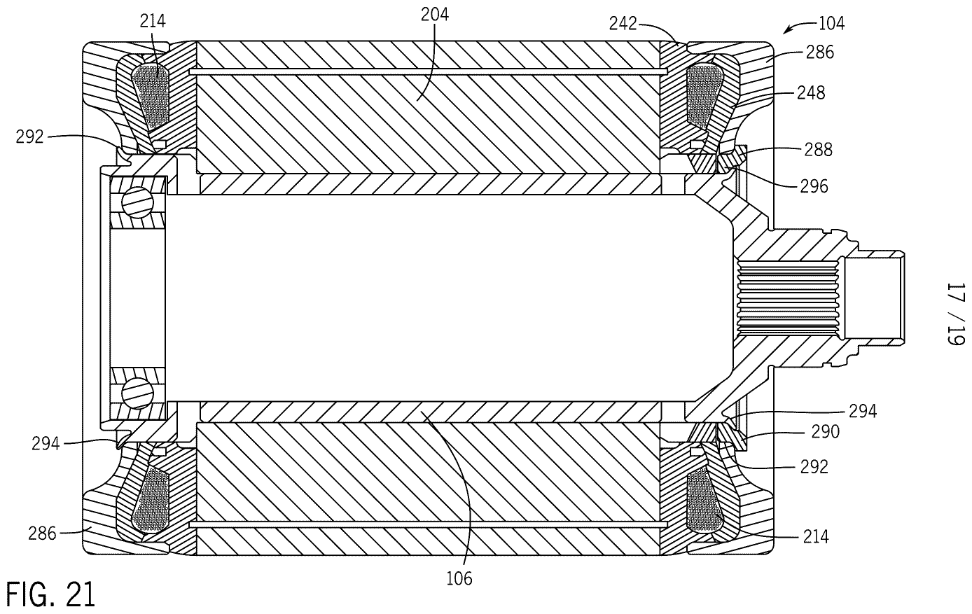

Referring now to FIG. 21, a cross-sectional view is illustrated of the rotor 104 which can include the rotor windings 214 that may be secured within the retainer 242. Further, the caps 248 can be configured as end plates for bolting or clamping the rotor 104 to apply an axial compression thereto, as discussed above. Another rotor component, such as a balance ring, can be used to secure the caps to the axial ends of the rotor to help minimize rotation imbalances in the rotor. For example, and as illustrated in the non-limiting example, the caps 248 can be coupled to the retainer 242. To help secure the caps 248 to the retainer 242, first balance rings 286 can be placed over each cap 248. That is, the first balance rings 286 can seat over the caps 248 to secure the caps 248 and rotor windings 214 between the first balance rings 286 and the retainer 242. In some cases, the retainer 242 can be configured to prevent rotation of the first balance rings 286 during operation, relative to the rest of the rotor 104 (e.g., to ensure co-rotation of all rotor components).

Further, in some examples, a second balance ring 288 can be at least partially seated over one or both of the first balance ring 286 to secure the first balance ring 286 between the cap(s) 248 and the second balance ring(s) 288. In particular, the second balance ring 288 can be bent or folded over a first balance ring 286 to secure the first balance ring 286 on the rotor 104 (e.g., via a roll-forming process). For example, an outer rim 290 of the second balance ring 288 can be bent or folded over a radially inner lip 292 of the first balance ring 286. In this way, the second balance ring 288 can act as a retention structure that provides axial compression to the rotor 104 and secures the first balance ring 286 to the rotor 104. In some examples, the second balance ring 288 can define a smaller diameter than that of the first balance ring 286, and the second balance ring 288 can be arranged concentrically with respect to the first balance ring 286. While only a single second balance ring is illustrated in the non-limiting example, it will be understood that multiple second balance rings may be used (e.g., a second balance ring positioned at either axial end of the rotor).

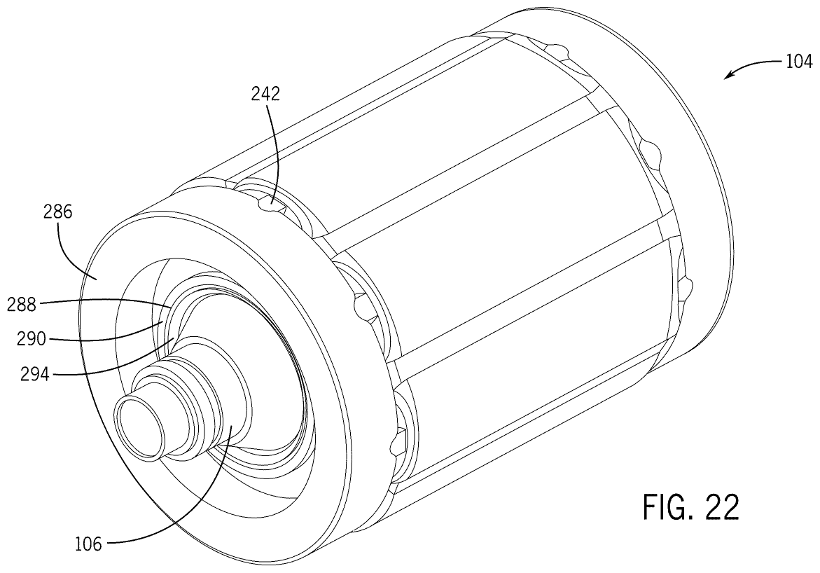

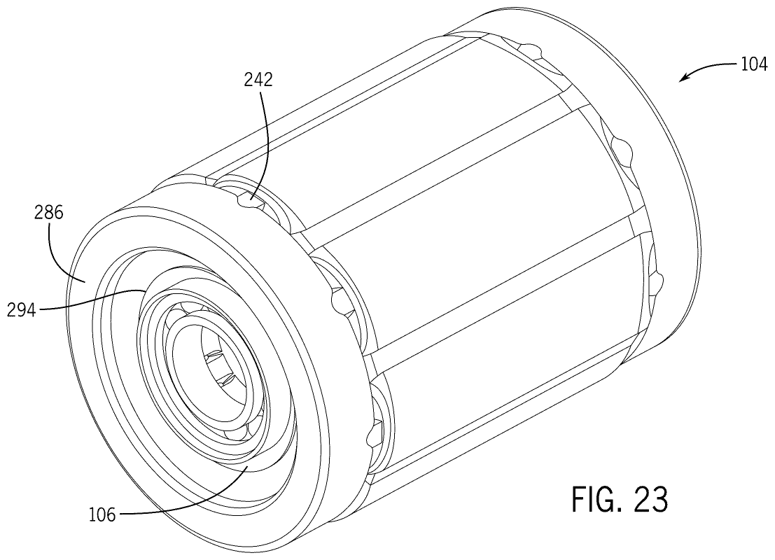

Thus, according to aspects of the disclosure, a balance ring can be secured without the use of separate fasteners, as are typically used in conventional rotor construction. In some examples, and with reference to FIGS. 21-23, the first balance rings 286 and/or the second balance ring 288 can be secured to the rotor 104 via the rotor shaft 106. More specifically, the rotor shaft 106 may include flanges 294 at each end. The flanges 294 can be bent or folded over the balance rings 286, 288 to secure the balance rings 286, 288 on the rotor 104 (e.g., via a roll-forming process). For example, the flanges 294 can be bent or folded over the radially inner lip 292 of the first balance rings 286, and/or the flanges 294 can be bent or folded over a base 296 of the second balance ring 288 (i.e., a base 296 that is unitary with and disposed radially inward with respect to the outer rim 290). In this way, the flanges 294 can act as retention structures that provide axial compression to the rotor 104. In particular, the flanges 294 can provide axial compression to the back iron 204, rotor windings 214, retainer 242, end caps 248, the first balance rings 286, and/or the second balance ring 288. By constructing the rotor 104 in this way, rotor complexity can be reduced while providing increased structural integrity. For example, the balance rings 286, 288 and the end caps 248, alone or in combination, can provide mechanical support to the rotor winding 214 over a range of rotor speeds.

As described above, the rotor may be used in combination with cooling devices. As used in the claims, the phrase “at least one of A, B, and C” means at least one of A, at least one of B, and/or at least one of C, or any one of A, B, or C or combination of A, B, or C. A, B, and C are elements of a list, and A, B, and C may be anything contained in the Specification.

The present invention has been described in terms of one or more particular embodiments, and it should be appreciated that many equivalents, alternatives, variations, and modifications, aside from those expressly stated, are possible and within the scope of the invention.

### FURTHER EXAMPLES

Example 1: A rotor for an electric machine comprising: a rotor body defining a rotor axis and a plurality of teeth extending radially away from the rotor axis, the rotor body including: a back iron; a plurality of shanks extending radially away from the back iron, each of the plurality of shanks corresponding to one of the plurality of teeth, and a plurality of pole caps, each of the plurality of pole caps being removably coupled to a corresponding one of the plurality of shanks; and a rotor winding wound around the plurality of teeth.

Example 2: The rotor of Example 1, wherein the plurality of pole caps is made of a first material and at least one of the back iron and the plurality of shanks is made of a second material that is different from the first material.

Example 3: The rotor of Example 2, wherein the first material is an electrical steel and the second material is a carbon steel.

Example 4: The rotor of Examples 2 or 3, wherein back iron is made of the second material and the plurality of shanks are made of a third material.

Example 5: The rotor of Example 4, wherein the second material is a first electrical steel with a first grain orientation and the third material is a second electrical steel with a second grain orientation.

Example 6: The rotor of Example 5, wherein the first grain orientation is oriented along a circumferential direction relative to the rotor axis and the second grain orientation is oriented along a radial direction relative to the rotor axis.

Example 7: The rotor of Examples 1 to 6, wherein the rotor body includes a lamination stack formed from a plurality of laminations that are stacked along the rotor axis.

Example 8: The rotor of Example 7, wherein each of the plurality of laminations is a monolithic lamination that forms both the back iron and the plurality of shanks.

Example 9: The rotor of Examples 7 or 8, wherein the plurality of laminations include a plurality of back iron laminations that collectively form the back iron and a plurality of shank laminations that collectively form the plurality of shanks.

Example 10: The rotor of Examples 7 to 9, further comprising a first end cap and a second end cap disposed at opposite ends of the rotor body to provide a clamping force to the plurality of laminations and retain the rotor winding on the rotor body.

Example 11: The rotor of Example 10, wherein each of the first end cap and the second end cap is made from at least one of polymeric material and a composite material.

Example 12: The rotor of Examples 1 to 11, wherein the plurality of pole caps are retained on the rotor body by a retention wrap.

Example 13: The rotor of Examples 1 to 12, wherein each of the plurality of pole caps is coupled to the corresponding one of the plurality of shanks by a lock-and-key coupling.

Example 14: The rotor of Examples 1 to 13, wherein each of the plurality of pole caps is coupled to the corresponding one of the plurality of shanks by a fastener.

Example 15: The rotor of Examples 1 to 14, wherein each of the plurality of shanks is coupled to the back iron by a lock-and key coupling.

Example 16: The rotor of Examples 1 to 15, wherein the back iron includes a plurality of back iron segments, each of the plurality of back iron segments being configured to couple to a corresponding one of the plurality of shanks.

Example 17: An electric machine, comprising: a stator; and a rotor configured to rotate relative to the stator, the rotor including: a rotor body defining a plurality of teeth, a rotor winding wound around the plurality of teeth, a retention wrap wrapped around the rotor body, the retention wrap being configured to apply a compressive force to retain the rotor winding on the rotor body, and a compliance member configured to maintain the retention wrap within a predetermined tension range.

Example 18: The electric machine of Example 17, wherein the predetermined tension range is between 10-percent and 50-percent of an ultimate strain of the retention wrap.

Example 19: The electric machine of Example 18, wherein the retention wrap is pretensioned to be at about 30-percent of an ultimate strain of the retention wrap.

Example 20: The electric machine of Examples 17 to 19, wherein the compliance member is positioned within a winding channel formed between two adjacent teeth of the plurality of teeth.

Example 21: The electric machine of Examples 17 to 20, wherein the compliance member is configured as a cooling can configured to enclose a coil of the rotor winding.

Example, 22: The electric machine of Examples 17 to 21, wherein the compliance member is positioned radially between the retention wrap and at least one of the rotor body and the rotor winding.

Example 23: The electric machine of Examples 17 to 22, wherein the retention wrap is wrapped circumferentially around the rotor body.

Example 24: The electric machine of Examples 17 to 23, wherein the retention is wrapped axially around the rotor body, the retention wrap extending between a first a channel formed between a first pair of adjacent teeth of the plurality of teeth and a second a channel formed between a second pair of adjacent teeth of the plurality of teeth.

Example 25: The electric machine of Example 24, wherein the rotor includes a first end cap and a second end cap positioned opposed ends of the rotor body, and wherein the retention wrap extends along each of the first end cap and the second end cap between the first and second channels to apply an axial compression to the rotor body.

Example 26: The electric machine of Examples 17 to 25, wherein the compliance member is configured to compensate for thermal expansion between the rotor and the retention wrap to maintain the retention wrap within the predetermined tension range.

Example 27: The electric machine of Examples 17 to 26, wherein the rotor further includes a retainer positioned between the retention wrap and the compliance member, the retainer being configured to maintain the retention wrap in a predetermined shape.

Example 28: The electric machine of Example 27, wherein the retainer and the compliance member are integrally formed as a retaining body.

Example 29: An electric machine with reconfigurable poles, the electric machine comprising: a stator; and a rotor configured to rotate relative to the stator, the rotor including a plurality of rotor windings wrapped around a corresponding plurality of teeth extending from a rotor core, the rotor core made of a magnetizable material and configured to be selectively magnetized in a first pole configuration with a first pole count and a second pole configuration with a second pole count that is different from the first pole count.

Example 30: The electric machine of Example 29, wherein the first pole count and the second pole count evenly divide a total number of teeth in the plurality of teeth.

Example 31: The electric machine of Examples 29 or 30, wherein at least one of: the plurality of teeth consists of four teeth, and the first pole count includes four poles and the second pole count includes two poles; the plurality of teeth consists of six teeth, and the first pole count includes six poles and the second pole count includes two poles; and the plurality of teeth consists of eight teeth and the first pole count and the second pole count are selected from the group consisting of: eight poles, four poles, and two poles.

Example 32: The electric machine of Examples 29 to 31, further comprising a controller configured to selectively magnetize the rotor core to switch between the first pole configuration and the second pole configuration.

Example 33: The electric machine of Example 32, wherein the controller is configured to switch between the first pole configuration and the second pole configuration based on an operating parameter of the electric machine.

Example 34: The electric machine of Example 33, wherein the operating parameter includes at least one of a torque output or a rotational speed of the electric machine.

Example 35: The electric machine of Examples 32 to 34, wherein the stator includes a stator winding and the controller is configured to control a flow of current in the stator winding that induces a corresponding current in the rotor core to switch the rotor core between the first pole configuration the second pole configuration.

Example 36: The electric machine of Examples 29 to 35, wherein each of the plurality of teeth include a pole cap made of an electrical steel and the rotor core is made of a carbon steel.

Example 37: A rotor assembly of an electric machine, the rotor comprising: a rotor shaft including a flange disposed on an end of the rotor shaft; a rotor body coupled to the rotor shaft; a rotor winding supported on the rotor body; and a balance ring that retains the rotor winding on the rotor body, the balance ring defines an inner lip and the flange bends over the inner lip to retain the rotor winding on the rotor shaft.

Example 38: The rotor assembly of Example 37, wherein the flange provides axial compression to the balance ring, the rotor winding, and the back iron relative to a rotor axis defined by the rotor shaft.

Example 39: The rotor assembly of Example 37, further comprising a retainer positioned between the rotor winding and the rotor body.

Example 40: The rotor assembly of Example 39, further comprising an end cap configured to enclose the rotor winding on the retainer, the end cap positioned between the rotor winding and the balance ring.

Example 41: The rotor assembly of Example 40, wherein further comprising an end cap configured to enclose the rotor winding on the retainer, the end cap positioned between the rotor winding and the balance ring.

Example 42: The rotor assembly of Example 41, wherein the second balance ring retains the first balance ring on the rotor shaft.

Example 43: The rotor assembly of Example 42, wherein the second balance ring defines an outer rim that bends over a second inner lip of the first balance ring to retain the first balance ring on the rotor shaft.

1. A rotor for an electric machine comprising:
a rotor body defining a rotor axis and a plurality of teeth extending radially away from the rotor axis, the rotor body including:
a back iron;
a plurality of shanks extending radially away from the back iron, each of the plurality of shanks corresponding to one of the plurality of teeth, and
a plurality of pole caps, each of the plurality of pole caps being removably coupled to a corresponding one of the plurality of shanks; and
a rotor winding wound around the plurality of teeth.

2. The rotor of claim 1, wherein the plurality of pole caps is made of a first material and at least one of the back iron and the plurality of shanks is made of a second material that is different from the first material.

3. The rotor of claim 2, wherein the first material is an electrical steel and the second material is a carbon steel.

4. The rotor of claim 2, wherein back iron is made of the second material and the plurality of shanks are made of a third material.

5. The rotor of claim 4, wherein the second material is a first electrical steel with a first grain orientation and the third material is a second electrical steel with a second grain orientation.

6. The rotor of claim 5, wherein the first grain orientation is oriented along a circumferential direction relative to the rotor axis and the second grain orientation is oriented along a radial direction relative to the rotor axis.

7. The rotor of claim 1, wherein the rotor body includes a lamination stack formed from a plurality of laminations that are stacked along the rotor axis.

8. The rotor of claim 7, wherein each of the plurality of laminations is a monolithic lamination that forms both the back iron and the plurality of shanks.

9. The rotor of claim 7, wherein the plurality of laminations include a plurality of back iron laminations that collectively form the back iron and a plurality of shank laminations that collectively form the plurality of shanks.

10. The rotor of claim 9, further comprising a first end cap and a second end cap disposed at opposite ends of the rotor body to provide a clamping force to the plurality of laminations and retain the rotor winding on the rotor body.

11. The rotor of claim 10, wherein each of the first end cap and the second end cap is made from at least one of polymeric material and a composite material.

12. The rotor of claim 1, wherein the plurality of pole caps are retained on the rotor body by a retention wrap.

13. The rotor of claim 1, wherein each of the plurality of pole caps is coupled to the corresponding one of the plurality of shanks by a lock-and-key coupling.

14. The rotor of claim 1, wherein each of the plurality of pole caps is coupled to the corresponding one of the plurality of shanks by a fastener.

15. The rotor of claim 1, wherein each of the plurality of shanks is coupled to the back iron by a lock-and-key coupling.

16. The rotor of claim 1, wherein the back iron includes a plurality of back iron segments, each of the plurality of back iron segments being configured to couple to a corresponding one of the plurality of shanks.

17.-43. (canceled)
